(19) United States
(12) Patent Application Publication
(10) Pub. No.: US 2015/0340167 A1
(43) Pub. Date: Nov. 26, 2015

(54) PHOTOELECTRIC CONVERSION ELEMENT

(71) Applicant: Panasonic Corporation, Osaka (JP)

(72) Inventors: MICHIO SUZUKA, Osaka (JP); NAOKI HAYASHI, Osaka (JP)

(21) Appl. No.: 14/711,772

(22) Filed: May 14, 2015

(30) Foreign Application Priority Data
May 20, 2014 (JP) 2014-104584
May 22, 2014 (JP) 2014-105774

(51) Int. Cl. H01G 9/20

(52) U.S. Cl. CPC H01G 9/2013; H01G 9/2077

(57) ABSTRACT

A photoelectric conversion element includes a photoanode, a counter electrode, and a liquid electrolyte between the photoanode and the counter electrode. The liquid electrolyte contains a nitroxyl radical-bearing compound, 0.2 mol/L or more and 0.5 mol/L or less of dimethylimidazolium cation, and an anion. The nitroxyl radical-bearing compound may be a radical compound that is 2,2,6,6-tetramethylpiperidine 1-oxyl or a derivative thereof. A mole fraction of an oxidized form of the radical compound, if any, in the liquid electrolyte may equal to or less than 5% of a total quantity of the radical compound and the oxidized form. A distance between the photoanode and the counter electrode may equal to or less than 30 μm.

### BACKGROUND

1. Technical Field

The present disclosure relates to a photoelectric conversion element that contains a liquid electrolyte containing a nitroxyl radical-bearing compound.

2. Description of the Related Art

Dye-sensitized solar cells, i.e., solar cells in which a dye is used as a photosensitizer, have been under active research and development in recent years. A known dye-sensitized solar cell typically has a dye-containing photoanode, a counter electrode, an electron transport layer and a hole transport layer between the photoanode and the counter electrode, and a liquid electrolyte containing a redox couple. For better characteristics of dye-sensitized solar cells, it is needed to improve the characteristics of these individual components.

Zhang et al. has disclosed a dye-sensitized solar cell that contains 2,2,6,6-tetramethylpiperidine 1-oxyl (hereinafter referred to as “TEMPO”), an iodine-free electrolyte and nitroxyl radical-bearing compound, as a mediator (Z. Zhang, P. Chen, T. N. Murakami, S. M. Zakeeruddin, M. Grätzel, Advanced Functional Materials 2008, 18, 341). The authors state that this solar cell, in which no iodine-containing electrolytes are used, has desirable durability.

International Publication No. 2011-118197 discloses a photoelectric conversion element with improved photoelectric conversion efficiency (hereinafter simply referred to as “conversion efficiency”), in which a TEMPO-containing radical compound has an average molecular weight of 200 or more.

Japanese Unexamined Patent Application Publication No. 2003-031270 discloses that the use of a liquid electrolyte containing imidazolium iodide and iodine as mediators can improve the durability and conversion efficiency of photoelectric conversion elements.

Furthermore, a publication describes that adding TEMPO cation (hereinafter also referred to as “TEMPO⁺”) in combination with TEMPO to a liquid electrolyte leads to improved fill factor (FF) and short-circuit current level (hereinafter also simply referred to as “current level”) (Angewandte Chemie International Edition, Volume 51, Issue 40, pages 10177-10180, Oct. 1, 2012 (DOI: 10.1002/anie.201205036)). These effects of adding an oxidized form of a mediator to a liquid electrolyte in a dye-sensitized solar cell have also been seen in other cases, for example, adding iodine to a liquid electrolyte based on iodide ions.

### SUMMARY

One non-limiting and exemplary embodiment provides a photoelectric conversion element that offers improved durability without compromising the high voltage of photoelectric conversion elements that use a liquid electrolyte in which a nitroxyl radical-bearing compound is contained as a mediator.

In one general aspect, the techniques disclosed here feature a photoelectric conversion element including a photoanode, a counter electrode, and a liquid electrolyte between the photoanode and the counter electrode, the liquid electrolyte containing a nitroxyl radical-bearing compound, 0.2 mol/L or more and 5 mol/L or less of dimethylimidazolium cation, and an anion.

A certain embodiment of the present disclosure can improve the durability of a photoelectric conversion element without compromising the high voltage of photoelectric conversion elements that use a liquid electrolyte in which a nitroxyl radical-bearing compound is contained as a mediator.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram schematically illustrating the structure of a photoelectric conversion element according to Embodiment 1 of the present disclosure;

FIG. 2 is a cross-sectional diagram schematically illustrating the structure of a photoelectric conversion element according to Embodiment 2 of the present disclosure; and

FIG. 3 is a cross-sectional diagram schematically illustrating the structure of a photoelectric conversion element according to Embodiment 3 of the present disclosure.

### DETAILED DESCRIPTION

### Underlying Knowledge Forming Basis of the Present Disclosure

The inventors' studies have found that the durability of the photoelectric conversion element described in International Publication No. 2011-118197 is lower than that of the photoelectric conversion element described in Japanese Unexamined Patent Application Publication No. 2003-031270, and that the open voltage (hereinafter also simply referred to as “voltage”) of the photoelectric conversion element described in Japanese Unexamined Patent Application Publication No. 2003-031270 is lower than that of the photoelectric conversion element described in International Publication No. 2011-118197. The inventors' studies also revealed that liquid electrolytes containing 2,2,6,6-tetramethylpiperidine 1-oxyl, a nitroxyl radical-bearing compound (hereinafter referred to as “TEMPO”), and TEMPO⁺ are of low stability and can be used only for a short period of time. A cause of this is the low stability of TEMPO⁺. To improve the performance of photosensitized photoelectric conversion elements, the inventors conducted extensive research. The photosensitized photoelectric conversion elements of interest include so-called dye-sensitized solar cells and photoelectrochemical power generation elements, which are elements capable of generating power even under relatively low-illuminance conditions, such as the indoors.

### EMBODIMENTS

The following describes some embodiments of the present disclosure with reference to drawings.

### Embodiment 1

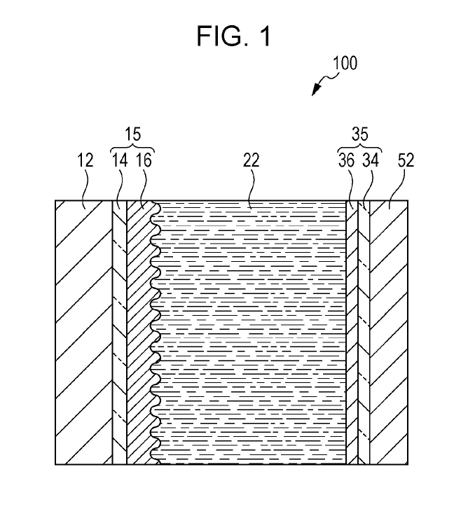

FIG. 1 schematically illustrates the structure of a photoelectric conversion element 100 according to Embodiment 1 of the present disclosure. The photoelectric conversion element 100 includes a photoanode 15, a counter electrode 35, and a liquid electrolyte 22 between the photoanode 15 and the counter electrode 35.

The photoanode 15 is supported on a substrate 12 and includes, for example, an electroconductive layer 14 permeable to visible light (also referred to as a “transparent electroconductive layer”) and a solid semiconductor layer 16 on the electroconductive layer 14. The solid semiconductor layer 16 contains dye molecules as a photosensitizer. The solid semiconductor layer 16 can be, for example, a porous semiconductor layer, desirably a porous titanium oxide layer. The solid semiconductor layer 16 may also be simply referred to as the semiconductor layer 16.

The counter electrode 35 faces the semiconductor layer 16 across the liquid electrolyte 22. The counter electrode 35 is supported on a substrate 52 and includes, for example, an electroconductive oxide layer 34 and a metal layer (e.g., a platinum layer) 36 on the electroconductive oxide layer 34.

The liquid electrolyte 22 can be, for example, a mediator-containing liquid electrolyte and is sealed between the photoanode 15 and the counter electrode 35 by a sealer.

The following describes the materials used to form these components of the photoelectric conversion element 100 in detail.

### Photoanode

The photoanode 15 serves as the anode of the photoelectric conversion element 100. As mentioned above, the photoanode 15 includes, for example, an electroconductive layer 14 permeable to visible light and a semiconductor layer 16 on the electroconductive layer 14, and the semiconductor layer 16 contains a photosensitizer. The photosensitizer-containing semiconductor layer 16 may also be referred to as a light-absorbing layer. The substrate 12 in this case can be, for example, a glass or plastic substrate (or a plastic film) permeable to visible light.

The electroconductive layer 14 permeable to visible light can be made of, for example, a material permeable to visible light (hereinafter referred to as a “transparent electroconductive material”). Examples of the transparent electroconductive material include zinc oxide, indium-tin composite oxide, a laminate of an indium-tin composite oxide layer and a silver layer, antimony-doped tin oxide, and fluorine-doped tin oxide. In particular, fluorine-doped tin oxide is desirable because of its significantly high electroconductivity and light permeability. The higher optical transmissivity of the electroconductive layer 14 the better, and it is desirable that the optical transmissivity of this layer be 50% or more, more desirably 80% or more.

The thickness of the electroconductive layer 14 can be, for example, in the range of 0.1 μm to 10 μm. This allows an electroconductive layer 14 of uniform thickness to be formed with preserved optical transmissivity, thereby ensuring that a sufficient amount of light enters the semiconductor layer 16. The lower the surface resistance of the electroconductive layer 14 the better, and it is desirable that the surface resistance of the electroconductive layer 14 be 200 Ω/cm² or less, more desirably 50 Ω/cm² or less. There is no particular lower limit for the surface resistance of the electroconductive layer 14, but a lower limit can be, for example, 0.1 Ω/cm². In general, photoelectric conversion elements for use under sunlight have an electroconductive layer with a sheet resistance of approximately 10 Ω/cm². The photoelectric conversion element 100, which is for use under light sources less illuminant than sunlight such as fluorescent lamps, is less susceptible to the resistive components in the electroconductive layer 14 because of the smaller amount of photoelectrons (i.e. a lower photocurrent level). As a result, it is desirable that the electroconductive layer 14 in the photoelectric conversion element 100 for use under low-illuminance conditions have a surface resistance of 30 to 200 Ω/cm² so that the production costs can be reduced through the reduction of the amount of electroconductive materials in the electroconductive layer 14.

The electroconductive layer 14 permeable to visible light can also be made of an electroconductive material with no light permeability. For example, it is possible to use a metal layer in a pattern of stripes, waves, mesh, or punched metal (i.e. many fine holes opened regularly or irregularly through the metal layer) or a metal layer having an inverted (i.e. negative to positive and vice versa) pattern. These metal layers allow light to pass through in portions where no metal exists. Examples of the metal include platinum, gold, silver, copper, aluminum, rhodium, indium, titanium, iron, nickel, tin, zinc, and alloys containing any of these metals. It is also possible to use an electroconductive carbon material instead of metal.

The transmissivity of the electroconductive layer 14 permeable to visible light can be, for example, 50% or more, desirably 80% or more. The wavelength of light that permeates through this layer depends on the absorption wavelength of the photosensitizer.

If light is allowed to enter the semiconductor layer 16 from the side opposite the substrate 12, the substrate 12 and the electroconductive layer 14 need not be permeable to visible light. In such an arrangement, therefore, the electroconductive layer 14 need not have a portion where no metal or carbon exists even if it is made of any of the metals mentioned above or carbon, and the electroconductive layer 14 can also serve as the substrate 12 if it is made of a sufficiently strong material.

Furthermore, there may be an oxide layer, such as a silicon oxide, tin oxide, titanium oxide, zirconium oxide, or aluminum oxide layer, between the electroconductive layer 14 and the semiconductor layer 16 to prevent electrons from leaking at the surface of the electroconductive layer 14, or in other words to rectify the electron flow between the electroconductive layer 14 and the semiconductor layer 16.

The photosensitizer-containing semiconductor layer 16 includes, for example, a porous semiconductor and a photosensitizer supported on the surface of the porous semiconductor. The porous semiconductor can be, for example, porous titanium oxide (TiO₂). Titanium oxide has good photoelectric conversion characteristics and is unlikely to dissolve in electrolytic solution upon exposure to light, and a porous material advantageously has a large specific surface area that allows a large amount of photosensitizer to be supported. A porous material is not the only possible form of the semiconductor layer 16. For example, the semiconductor layer 16 may be composed of aggregates of semiconductor particles.

It is desirable that the particle diameter of the semiconductor particles be in the range of 5 to 1000 nm, more desirably 10 to 100 nm. The use of semiconductor particles having a particle diameter of 5 to 1000 nm provides the semiconductor layer 16 with a surface area large enough to adsorb a sufficient amount of photosensitizer, thereby ensuring a high efficiency of use of light. Furthermore, the use of semiconductor particles of such a size provides the semiconductor layer 16 with voids of a moderate size, which allow the liquid electrolyte (i.e. an electrolytic medium and charge transport material) to penetrate sufficiently deep into the semiconductor layer 16 and ensure excellent photoelectric conversion characteristics.

It is desirable that the thickness of the semiconductor layer 16 be in the range of 0.1 to 100 μm, more desirably 1 to 50 μm, even more desirably 3 to 20 μm, most desirably 5 to 10 μm. The semiconductor layer 16 offers sufficient photoelectric conversion effects and sufficient permeability to visible light and near infrared light when having a thickness in this range. The thickness of the semiconductor layer 16 in this photoelectric conversion element 100 may be smaller than the ideal thickness of a semiconductor layer in known photoelectric conversion elements intended for use under sunlight (e.g., 10 μm).

The thickness of the semiconductor layer 16 can be, for example, 0.01 μm or more and 100 μm or less. The thickness of the semiconductor layer 16 may be changed as necessary for the intended photoelectric conversion efficiency, but it is desirable that it be 0.5 μm or more and 50 μm or less, more desirably 1 μm or more and 20 μm or less. The larger the surface roughness of the semiconductor layer 16 is the better, and it is desirable that the surface roughness factor, given as the effective area divided by the projected area, be 10 or more, more desirably 100 or more. The effective area represents an effective surface area calculated from the volume of the semiconductor layer 16 (determined from the projected area and the thickness) and the specific surface area and bulk density of the material making up the semiconductor layer 16.

Besides TiO₂, the semiconductor layer 16 can be made of the following inorganic semiconductors. For example, oxides of metallic elements such as Cd, Zn, In, Pb, Mo, W, Sb, Bi, Cu, Hg, Ti, Ag, Mn, Fe, V, Sn, Zr, Sr, Ga, Si, and Cr, perovskites such as SrTiO₃ and CaTiO₃, sulfides such as CdS, ZnS, In₂S₃, PbS, Mo₂S, WS₂, Sb₂S₃, Bi₂S₃, ZnCdS₂, and Cu₂S, metal chalcogenides such as CdSe, In₂Se₃, WSe₂, HgS, PbSe, and CdTe, and GaAs, Si, Se, Cd₂P₃, Zn₂P₃, InP, AgBr, PbI₂, HgI₂, BiI₃, and similar materials can be used. In particular, CdS, ZnS, In₂S₃, PbS, Mo₂S, WS₂, Sb₂S₃, Bi₂S₃, ZnCdS₂, Cu₂S, InP, Cu₂O, CuO, and CdSe are advantageously capable of absorbing light with a wavelength of approximately 350 nm to 1300 nm. Composite semiconductors containing at least one selected from the semiconductors mentioned above can also be used, including CdS/TiO₂, CdS/AgI, Ag₂S/AgI, CdS/ZnO, CdS/HgS, CdS/PbS, ZnO/ZnS, ZnO/ZnSe, CdS/HgS, CdSₓ/CdSe₁₋ₓ, CdSₓ/Te₁₋ₓ, CdSeₓ/Te₁₋ₓ, ZnS/CdSe, ZnSe/CdSe, CdS/ZnS, TiO₂/Cd₃P₂, CdS/CdSeCd_{y}Zn_{1-y}S, and CdS/HgS/CdS. Organic semiconductors such as polyphenylene vinylene, polythiophene, polyacetylene, tetracene, pentacene, and phthalocyanine can also be used. It is also possible to use a viologen polymer, a quinone polymer, or a similar material.

Furthermore, the semiconductor layer 16 may be an organic compound that has redox-active moieties, i.e., a moiety that can be repeatedly oxidized and reduced, as a part of the molecule and a moiety that swells and forms a gel by absorbing electrolytic solution as another part (e.g., see Japanese Unexamined Patent Application Publication No. 2010-526633).

Various known methods can be used to form the semiconductor layer 16. If an inorganic semiconductor is used, a semiconductor layer 16 made of the inorganic semiconductor can be obtained by applying a mixture of a powder of the semiconductor material and an organic binder (containing an organic solvent) to the electroconductive layer 14 and then removing the organic binder through heating. Various known coating or printing processes can be used to apply the mixture. Examples of the coating processes include doctor blade coating, bar coating, spraying, dip coating, and spin coating, and examples of the printing processes include screen printing. The film of the mixture may optionally be compressed.

The semiconductor layer 16 can be formed using various known methods even if an organic semiconductor is used. An example is to apply a solution of the organic semiconductor to the electroconductive layer 14 using any known coating or printing process. For the case where, for example, a semiconductive polymer having a number average molecular weight of 1000 or more is used, examples of the coating process include spin coating and drop casting, and examples of the printing process include screen printing and gravure printing. Besides these wet processes, dry processes such as sputtering and vapor deposition can be used.

Examples of materials that can be used as the photosensitizer include semiconductive ultrafine particles, dyes, and pigments. The photosensitizer can be an inorganic or organic material or a mixture of them. For efficient light absorption and charge separation, it is desirable to use a dye, and examples of the dye include 9-phenyl xanthene dyes, coumarin dyes, acridine dyes, triphenylmethane dyes, tetraphenylmethane dyes, quinone dyes, azo dyes, indigo dyes, cyanine dyes, merocyanine dyes, and xanthene dyes. Other materials can also be used, including ruthenium-cis-diaqua-bipyridyl complexes of a type of RuL₂(H₂O)₂ (where L represents 4,4′-dicarboxy-2,2′-bipyridine), transition metal complexes of types such as ruthenium-tris (RuL₃), ruthenium-bis (RuL₂), osmium-tris (OsL₃), and osmium-bis (OsL₂), zinc-tetra(4-carboxyphenyl)porphyrin, iron-hexacyanide complexes, and phthalocyanine. The dyes mentioned in a section about DSSC of a book in Japanese about “the cutting-edge technologies and material development concerning FPD, DSSC, optical memories, and functional dyes” (NTS Inc.) can also be used. In particular, associative dyes can serve as an insulating layer by densely aggregating and covering the surface of the semiconductor. When the photosensitizer serves as an insulating layer, the flow of charge in the charge separation interface (the interface between the photosensitizer and the semiconductor) is rectified and, as a result, the recombination of separated charge is reduced.

Desirable associative dyes include dye molecules having a structure represented by chemical formula 2, such as dye molecules having a structure represented by chemical formula 3. The formation of assemblies of dye molecules can be easily confirmed by comparing the absorption spectrum of the dye molecules in an organic solvent or any other solvent and that of the dye molecules on the semiconductor.

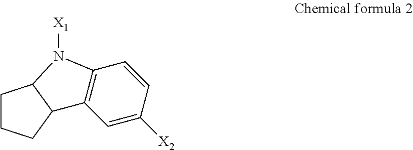

(Each of X₁ and X₂ independently includes at least one group selected from alkyl groups, alkenyl groups, aralkyl groups, aryl groups, and heterocycles, and each of the at least one group may independently have a substituent. X₂ includes, for example, a carboxyl group, a sulfonyl group, or a phosphonyl group.)

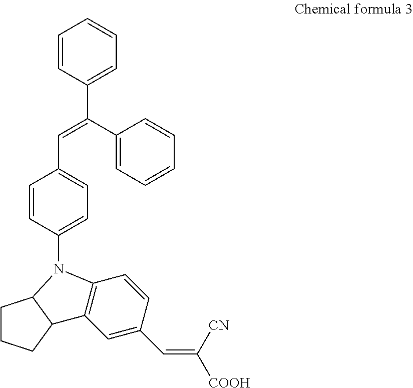 [SMILES: N#C/C(=C\c1ccc2c(c1)C1CCCC1N2c1ccc(C=C(c2ccccc2)c2ccccc2)cc1)C(=O)O]

Examples of semiconductive ultrafine particles that can be used as the photosensitizer include ultrafine particles of semiconductive sulfides such as cadmium sulfide, lead sulfide, and silver sulfide. The diameter of the semiconductive ultrafine particles can be, for example, in the range of 1 nm to 10 nm.

Various known methods can be used to make the photosensitizer supported on the semiconductor. An example of a method is to coat a substrate with a semiconductor layer (e.g., a porous semiconductor containing no photosensitizer) and immerse this substrate in a solution in which the photosensitizer is dissolved or dispersed. The solvent in this solution can be any appropriate solvent in which the photosensitizer is soluble, such as water, an alcohol, toluene, or dimethylformamide. The substrate may be heated or sonicated while in the solution of the photosensitizer. After immersion, the substrate may be washed with the solvent (e.g., an alcohol) and/or heated so that any excess of the photosensitizer is removed.

The amount of photosensitizer supported on the semiconductor layer 16 can be, for example, in the range of 1×10⁻¹⁰ to 1×10⁻⁴ mol/cm², desirably 0.1×10⁻⁸ to 9.0×10⁻⁶ mol/cm² in light of the photoelectric conversion efficiency and costs.

If the semiconductor layer 16 is made of CdS, ZnS, In₂S₃, PbS, Mo₂S, WS₂, Sb₂S₃, Bi₂S₃, ZnCdS₂, Cu₂S, InP, Cu₂O, CuO, or CdSe, which are capable of absorbing light with a wavelength of approximately 350 nm to 1300 nm as mentioned above, the photosensitizer is unnecessary.

### Counter Electrode

The counter electrode 35 serves as the cathode of the photoelectric conversion element 100. Examples of materials for the counter electrode 35 include metals such as platinum, gold, silver, copper, aluminum, rhodium, and indium, carbon materials such as graphite, carbon nanotubes, and platinum on carbon, electroconductive metal oxides such as indium-tin composite oxide, antimony-doped tin oxide, and fluorine-doped tin oxide, and electroconductive polymers such as polyethylenedioxythiophene, polypyrrole, and polyaniline. In particular, platinum, graphite, polyethylenedioxythiophene, and similar materials are desirable.

As illustrated in FIG. 1, the counter electrode 35 may have a transparent electroconductive layer 34 on the substrate 52 side. The transparent electroconductive layer 34 can be made of the same material as the electroconductive layer 14 of the photoanode 15. In this case, it is desirable that the counter electrode 35 also be transparent. If the counter electrode 35 is transparent, light can be received on any of the substrate 52 side and the substrate 12 side. This is effective if it is expected that the photoelectric conversion element 100 will be irradiated with light on both of its front and back sides because of reflected light or other effects.

### Liquid Electrolyte

The liquid electrolyte 22 is an electrolytic solution or an ionic liquid. The liquid electrolyte 22 contains a nitroxyl radical-bearing compound, 0.2 mol/L or more and 5 mol/L or less of dimethylimidazolium cation, and an anion. As long as these components are contained, a supporting electrolyte (a supporting salt) and a solvent may be added as necessary.

The concentration of any mediator other than the nitroxyl radical-bearing compound (e.g., iodine or a cobalt complex) in the liquid electrolyte 22 does not exceed 0.001 mol/L. The concentration of the nitroxyl radical-bearing compound in this case is, for example, 200 mol/L or more. The nitroxyl radical-bearing compound may be the only substantial mediator in the liquid electrolyte 22. An example of the nitroxyl radical-bearing compound is TEMPO.

The term “substantial” here means that the nitroxyl radical-bearing compound itself plays the main role in its oxidization and reduction, with almost no other mediators involved. The term “plays the main role in its oxidization and reduction” means that in the waveform of a cyclic voltammogram of the liquid electrolyte measured during oxidation or reduction, the CV capacity derived from the nitroxyl radical-bearing compound is at least 10 times as large as that derived from the other mediator component or any one of the other mediator components.

The nitroxyl radical, represented by chemical formula 4, is a compound that has the potential for repeated stable oxidization and reduction and reversibly switches between the forms of nitroxyl radical and oxoammonium cation. The nitroxyl radical-bearing compound serves as a mediator while in the liquid electrolyte. Photoelectric conversion elements containing mediators of this type are known to exhibit high voltage.

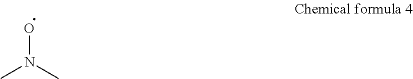

An imidazolium cation is a compound represented by chemical formula 5.

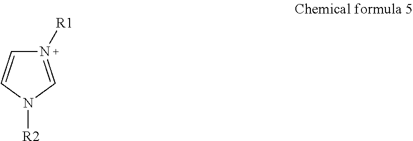

Each of R1 and R2 independently represents an alkyl group. It is desirable that each of R1 and R2 independently be an alkyl chain having two or less carbon atoms, more desirably a methyl group.

The anion contained in the liquid electrolyte as a counteranion of the imidazolium cation is at least one selected from, for example, halide anions, boron halide anions, phosphorus halide anions, and fluorocarbon anions. Examples of the halide anions include the chloride ion and the bromide ion. Examples of the boron halide anions include BF₄⁻ (tetrafluoroborate anion), and examples of the phosphorus halide anions include PF₆⁻ (hexafluorophosphate anion). Examples of the fluorocarbon anions include TFSI⁻ (bis(trifluoromethanesulfonyl)imide), BETI⁻ (bis(pentafluoroethanesulfonyl)imide), and the trifluoromethane anion.

Fluoroalkyl anions, in particular, TFSI⁻ and BETI⁻, are desirable in light of resistance to heat. When present as the counteranion of the imidazolium cation, these anions form a liquid (ionic liquid) with the cation at room temperature, thereby providing a nonvolatile liquid electrolyte. Chemical formula 6 is the chemical formula of TFSI⁻.

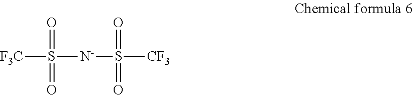 [SMILES: O=S(=O)([N-]S(=O)(=O)C(F)(F)F)C(F)(F)F]

It has been found that when present in a liquid electrolyte in which a nitroxyl radical-bearing compound serves as a mediator, imidazolium cations having the above-described characteristics increases the stability of the oxoammonium cation that occurs in response to irradiation with light. The effect of adding an imidazolium cation (abbreviated to “EMIm”) on the redox potential of TEMPO is as follows:

Redox potential of TEMPO in LiTFSI: +0.71 V (vs. Ag/Ag⁺)

Redox potential of TEMPO in EMImTFSI: +0.69 V (vs. Ag/Ag⁺)

As can be seen from this, adding an imidazolium salt makes the redox potential of TEMPO⁺ (oxoammonium cation) shift toward negative values.

The positive effect of adding the imidazolium cation on the durability of the photoelectric conversion element can therefore be speculated as follows. The following is the inventors' speculation and is not intended to limit the present disclosure.

The low durability of known photoelectric conversion elements that contain a liquid electrolyte containing TEMPO as a mediator is attributable to the high oxidative properties of the TEMPO cation, a state of TEMPO that has received holes. The inventors speculate that adding an imidazolium cation reduces the oxidative properties of the TEMPO cation, thereby leading to improved durability.

As in the experimental examples presented hereinafter, it is desirable that the concentration of the dimethylimidazolium cation be 0.2 mol/L or more, more desirably 2 mol/L or more. The upper limit is the concentration achieved when all liquid electrolyte is a dimethylimidazolium salt (i.e., an ionic liquid), usually approximately 5 mol/L.

Examples of the supporting electrolyte include tetrabutylammonium perchlorate, tetraethylammonium hexafluorophosphate, ammonium salts such as imidazolium salts and pyridinium salts, and alkali metal salts such as lithium perchlorate and potassium tetrafluoroborate.

It is desirable that the solvent be highly ion conductive. The solvent can be an aqueous or organic one, but organic solvents are desirable for higher stability of the solutes. Examples of the solvent include carbonate compounds such as dimethyl carbonate, diethyl carbonate, methyl ethyl carbonate, ethylene carbonate, and propylene carbonate, ester compounds such as methyl acetate, methyl propionate, and γ-butyrolactone, ether compounds such as diethyl ether, 1,2-dimethoxyethane, 1,3-dioxolane, tetrahydrofuran, and 2-methyl-tetrahydrofuran, heterocyclic compounds such as 3-methyl-2-oxazolidinone and 2-methylpyrrolidone, nitrile compounds such as acetonitrile, methoxyacetonitrile, and propionitrile, and aprotic polar compounds such as sulfolane, dimethylsulfoxide, and dimethylformamide. Each of these solvents can be used alone, and it is also possible to use a mixture of two or more. In particular, ethylene carbonate, propylene carbonate, and similar carbonate compounds, γ-butyrolactone, 3-methyl-2-oxazolidinone, 2-methylpyrrolidone, and similar heterocyclic compounds, and acetonitrile, methoxyacetonitrile, propionitrile, 3-methoxypropionitrile, valeronitrile, and similar nitrile compounds are desirable.

The solvent can also be an ionic liquid compatible with imidazolium salt-based ionic liquids or a mixture of such an ion liquid and any of the solvents listed above. Ionic liquids are of low volatility and high flame retardancy.

Any known ionic liquid can be used, and examples of the ionic liquid include imidazolium-based ionic liquids such as 1-ethyl-3-methylimidazolium tetracyanoborate, pyridine-based, alicyclic amine-based, aliphatic amine-based, and azonium amine-based ionic liquids, and the ionic liquids mentioned in European Patent No. 718288, International Publication No. 95/18456, Electrochemistry Vol. 65, No. 11, page 923 (1997), J. Electrochem. Soc. Vol. 143, No. 10, page 3099 (1996), and Inorg. Chem. Vol. 35, page 1168 (1996).

It is desirable that in a photoelectric conversion element according to the present disclosure, the section where the liquid electrolyte is sealed be a rectangular section with short sides not exceeding 50 mm. The basic unit of photoelectric conversion elements is herein referred to as a cell, a package in which a required number of cells are arranged is referred to as a module, and a group of multiple arranged and connected modules is referred to as an array. A photoelectric conversion element according to the present disclosure can be in any of these forms, i.e., a cell, a module, or an array. The section where the liquid electrolyte is sealed corresponds to a cell, the basic unit of photoelectric conversion elements. When a photoelectric conversion element according to the present disclosure includes a rectangular cell, therefore, it is desirable that the length of the short sides of the cell be 50 mm or less, more desirably 30 mm or less. When the length of the short sides of the cell is 50 mm or less, despite the high viscosity of the imidazolium salt, the liquid electrolyte penetrates sufficiently deep into the cell, and this improve the yield of the production of cells.

### Embodiment 2

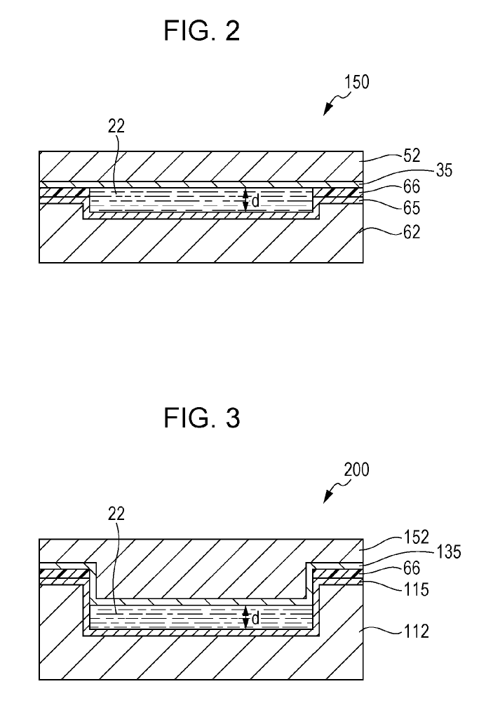

FIG. 2 schematically illustrates the structure of a photoelectric conversion element 150 according to Embodiment 2 of the present disclosure. The components equivalent to those in Embodiment 1 have the same reference numerals as in that embodiment and are not described in this embodiment. The photoelectric conversion element 150 according to Embodiment 2 includes a photoanode 65, a counter electrode 35, and a liquid electrolyte 22 between the photoanode 65 and the counter electrode 35. The photoanode 65 is supported on a substrate 62. The structure of the photoelectric conversion element 150 is different from that of the photoelectric conversion element 100 according to Embodiment 1 in that the substrate 62 has a depression where the liquid electrolyte 22 is sealed by a sealer 66, and the rest of the structure is the same as that of the photoelectric conversion element 100 according to Embodiment 1.

The liquid electrolyte 22 contains a nitroxyl radical-bearing compound as a mediator. The nitroxyl radical-bearing compound can be, for example, a radical compound that is either TEMPO or a derivative of TEMPO (hereinafter also referred to as a TEMPO-containing radical compound). The liquid electrolyte 22 contains, for example, no oxidized form of the radical compound (oxoammonium cation), and even if it contains the oxidized compound, the mole fraction of the oxidized compound based on the total quantity of the radical and oxidized compounds does not exceed 5%. It is desirable that the concentration of the radical compound in the liquid electrolyte 22 do not exceed 50 mmol/L (50 mM), more desirably not exceeding 30 mmol/L (30 mM). When the concentration of the radical compound is too high, an increased viscosity of the liquid electrolyte 22 and a reduced rate of diffusion of the radical compound may affect the current level.

When the radical compound is TEMPO, its oxidized form is TEMPO⁺. The mole fraction of this oxidized form is represented by the following formula, where [TEMPO] and [TEMPO⁺] represent their respective molarities (mol/L):

Mole fraction of oxidized form=[TEMPO⁺]/([TEMPO]+[TEMPO⁺])

Examples of the TEMPO-containing radical compound include TEMPO and compounds having one or more functional groups attached to one or more portions of TEMPO. Examples of the functional groups include a hydroxyl group, a carboxyl group, an amino group, and a cyano group. It is desirable that the molecular weight of the radical compound be less than 200. When having a molecular weight less than 200, the radical compound diffuses sufficiently in a semiconductor layer of the photoanode 65.

The liquid electrolyte 22 is sealed between the photoanode 65 and the counter electrode 35 by a sealer 66, in such a manner that the distance d between the photoanode 65 and the counter electrode 35 does not exceed 30 μm. In this structure, a liquid electrolyte 22 containing a TEMPO-containing radical compound is used. The mole fraction of the oxidized form of the radical compound, if any, in the liquid electrolyte 22 does not exceed 5% of the total quantity of the radical and oxidized compounds, and the distance d between the photoanode 65 and the counter electrode 35 (also referred to as the “cell gap”) does not exceed 30 μm. The use of this structure provides a photoelectric conversion element that offers a high conversion efficiency. There is no particular lower limit of the cell gap d, unless the photoanode 65 and the counter electrode 35 are in contact with each other. The cell gap d can be, for example, 1 μm or more.

The cell gap d can be adjusted through the control of the process conditions under which the sealer 66 is formed from a resin-containing sealant. Examples of sealants that can be used in this embodiment include heat-activated bonding films and curable resins. Examples of the curable resins that can be used include thermosetting resins and ultraviolet-curable resins. These resins may optionally be mixed with a gap material (also known as a spacer).

A cell gap d of 30 μm or less can be ensured by, for example, using a substrate 62 having a depression as illustrated in FIG. 2. The depth of the depression can be, for example, 10 μm or more. The depression can have any appropriate depth selected according to parameters such as the thickness of the photoanode 65 and the thickness of the sealer 66.

In the photoelectric conversion element 150 according to this embodiment, the liquid electrolyte 22 contains 0.2 mol/L or more and 5 mol/L or less of dimethylimidazolium cation, an anion, and a radical compound that is either TEMPO or its derivative. Even if the liquid electrolyte 22 also contains the oxidized form of the radical compound, the mole fraction of this oxidized compound does not exceed 5% of the total quantity of the radical and oxidized compounds. Furthermore, the distance between the photoanode 65 and the counter electrode 35 does not exceed 30 μm. This structure provides a high short-circuit current level and a high FF.

### Embodiment 3

FIG. 3 is a schematic cross-sectional view of a photoelectric conversion element 200 according to Embodiment 3 of the present disclosure. The components equivalent to those in Embodiment 2 have the same reference numerals as in that embodiment and are not described in this embodiment. The photoelectric conversion element 200 according to Embodiment 3 includes a photoanode 115, a counter electrode 135, and a liquid electrolyte 22 between the photoanode 115 and the counter electrode 135. The photoanode 115 is supported on a substrate 112, and the counter electrode 135 is supported on a substrate 152. The structure of the photoelectric conversion element 200 is different from that of the photoelectric conversion element 150 according to Embodiment 2 in that the substrate 152 has a protrusion partially disposed in the depression of the substrate 112, and the rest of the structure is the same as that of the photoelectric conversion element 150 according to Embodiment 2. The photoanode 115 and the counter electrode 135 are electrically insulated from each other. For example, a separator is interposed between the photoanode 115 and the counter electrode 135. Other modifications can also be made, such as a smaller width of the protrusion of the substrate 152.

Photoelectric conversion elements according to embodiments of the present disclosure are not limited to the above examples. The two substrates supporting the photoanode and the counter electrode may have a flat surface on the liquid electrolyte side. The cell gap d in this arrangement can be controlled through the use of a mixture of resin and a gap material as the sealant that forms the sealer.

The use of this structure, in which a liquid electrolyte containing a TEMPO-containing radical compound is used, the mole fraction of the oxidized form of the radical compound, if any, in the liquid electrolyte does not exceed 5% of the total quantity of the radical and oxidized compounds, and the cell gap d does not exceed 30 μm, provides a photoelectric conversion element that offers a high conversion efficiency. The reason for this can be speculated as follow. The following is the inventors' speculation and is not intended to limit the present disclosure.

In general, when the photoanode of a dye-sensitized solar cell is irradiated with light, a reaction through which the reduced form of the mediator turns into the oxidized form occurs in the liquid electrolyte near the photoanode, and a redox reaction through which the oxidized mediator turns into the reduced mediator on the counter electrode side. It is said that if no oxidized form, or only the reduced form, of the mediator is present in the liquid electrolyte, the lack of the oxidized mediator and the resultant limited reaction of it on the counter electrode side lead to a lowered current level. TEMPO, however, is known to perform fast electron self-exchange reaction and a fast electrode response rate and, as a result, quickly move in a liquid electrolyte because of its high diffusibility and perform efficient electrode reaction (i.e. giving and receiving holes) even when existing in a very small amount.

These suggest that even when the liquid electrolyte contains TEMPO but is free from the oxidized form of TEMPO, a sufficiently small cell gap d ensures that oxidized TEMPO generated on the photoanode side quickly diffuses toward the counter electrode side, and the resultant efficient electrode reaction between the oxidized compound and the counter electrode provides the effects described above.

It is desirable that in a photoelectric conversion element according to the present disclosure, the section where the liquid electrolyte is sealed be a rectangular section with short sides not exceeding 50 mm. The basic unit of photoelectric conversion elements is herein referred to as a cell, a package in which a required number of cells are arranged is referred to as a module, and a group of multiple arranged and connected modules is referred to as an array. A photoelectric conversion element according to the present disclosure can be in any of these forms, i.e., a cell, a module, or an array. The section where the liquid electrolyte is sealed corresponds to a cell, the basic unit of photoelectric conversion elements. When a photoelectric conversion element according to the present disclosure includes a rectangular cell, therefore, it is desirable that the length of the short sides of the cell be 50 mm or less, more desirably 30 mm or less. When the length of the short sides of the cell is 50 mm or less, the current level increases linearly with decreasing cell gap relative to the area of the cell and does not plateau out. Even a cell having short sides longer than 50 mm can offer sufficient output for the area and a high current level when its area is small. The length of the long sides of the cell has no effect on the current level as long as current is taken out along the short sides of the cell.

### EXAMPLES

The following describes the present disclosure in more detail by providing some examples. Photoelectric conversion elements of Example 2, Experimental Examples 1 and 3 to 7, and Comparative Examples 1 to 9 were prepared, and their characteristics were evaluated. Table 1 summarizes the composition of the liquid electrolyte and the results of the evaluation.

### Experimental Example 1

A photoelectric conversion element was produced having substantially the same structure as the photoelectric conversion element 100 illustrated in FIG. 1 except for the liquid electrolyte. The following components were used.

Substrate 12: A glass substrate, 1 mm in thickness

Transparent conductive film 14: A fluorine-doped SnO₂ layer (a surface resistance of 10 Ω/cm²)

Semiconductor layer 16: Porous titanium oxide and a photosensitizing dye (D358, Mitsubishi Paper Mills)

Liquid electrolyte: An electrolytic solution of TEMPO in ethylmethylimidazolium bis(trifluoromethanesulfonyl)imide

Substrate 52: A glass substrate, 1 mm in thickness

Electroconductive oxide layer 34: A fluorine-doped SnO₂ layer (a surface layer of 10 Ω/cm²)

Metal layer 36: A platinum layer

The photoelectric conversion element of Experimental Example 1 was prepared as follows.

Two 1-mm thick electroconductive glass substrates having a fluorine-doped SnO₂ layer (Asahi Glass) were prepared. These substrates were used as a substrate having a transparent electroconductive layer and a substrate having an electroconductive oxide layer.

A high-purity titanium oxide powder having an average primary particle diameter of 20 nm was dispersed in ethyl cellulose to form a paste for screen printing.

A titanium oxide layer having a thickness of approximately 10 nm was formed through sputtering on the fluorine-doped SnO₂ layer of one electroconductive glass substrate, and the above paste was applied to the titanium oxide layer and dried. The obtained dry material was fired at 500° C. for 30 minutes in the air to form a porous titanium oxide layer (i.e. titanium coating) having a thickness of 2 μm.

The substrate with the porous titanium oxide layer was then immersed in a solution containing 0.3 mM of a photosensitizing dye represented by chemical formula 7 (D358, Mitsubishi Paper Mills) in a 1:1 solvent mixture of acetonitrile and butanol. The substrate in the solution was then left in the dark at room temperature for 16 hours so that the photosensitizer was supported on the porous titanium oxide layer. In this way, a photoanode was formed.

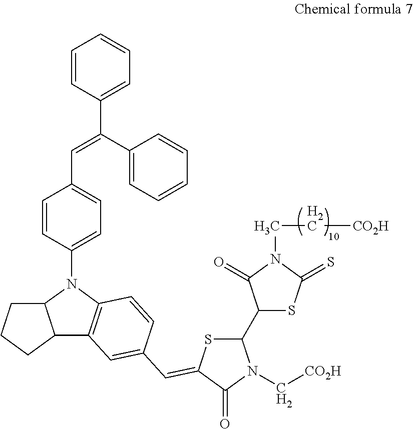

Then a counter electrode was formed by depositing a layer of platinum on the electroconductive oxide layer of the other glass substrate through sputtering.

A heat-melt adhesive agent (“Bynel,” Du Pont-Mitsui Polychemicals) as a sealant was applied to the glass substrate having two electroconductive portions in such an arrangement that the porous titanium oxide layer of the photoanode would be surrounded. The glass substrate bearing the photoanode was then placed on this substrate, and the two substrates were joined through thermal compression. An opening was made in the glass substrate bearing the counter electrode beforehand using a drill with a diamond bit.

An electrolytic solution containing 0.01 mol/L of TEMPO in ethylmethylimidazolium bis(trifluoromethanesulfonyl)imide was then prepared, and this liquid electrolyte was injected through the opening. In this way, the photoelectric conversion element of Experimental Example 1 was obtained.

This photoelectric conversion element was irradiated with light with an illuminance of 200 lx using a fluorescent lamp for stabilization, and the conversion efficiency after stabilization was determined through the measurement of the current-voltage characteristics. This condition of measurement is approximately 1/500 of sunlight, but the uses include conditions under sunlight and are not limited to this. The results are summarized in Table 1.

Furthermore, the conversion efficiency of this photoelectric conversion element was measured after storage at 85° C. for 100 hours, and the retention rate defined by the equation below was used to evaluate the durability (resistance to heat) of the element (as per JIS C 8938).

Retention rate=(Initial conversion efficiency)/(Conversion efficiency after storage at 85° C. for 100 hours

### Example 2, Experimental Examples 3 to 7, and Comparative Examples 1 to 9

Photoelectric conversion elements of Example 2, Experimental Examples 3 to 7, and Comparative Examples 1 to 9 were obtained by changing the liquid electrolyte in the photoelectric conversion element of Experimental Example 1. These photoelectric conversion elements were produced using the same method as in Experimental Example 1. Table 1 summarizes the compositions of the liquid electrolytes and the results of the evaluations of characteristics.

TABLE 1

| | | | | | Initial | Initial | Initial | Retention |
|---|---|---|---|---|---|---|---|---|
| | | | | Concentration | voltage | current | efficiency | rate (%) |
| | Cation | Anion | Mediator | (mol/L) | (mV) | (μA) | (%) | 85° C. 100 h |
| Experimental | Ethylmethylimidazolium | TFSI− | TEMPO | 4.5 | 830 | 20 | 19 | 80 |
| Example 1 | | | | | | | | |
| Example 2 | Dimethylimidazolium | TFSI− | TEMPO | 4.5 | 830 | 20 | 19 | 88 |
| Experimental | Butylmethylimidazolium | TFSI− | TEMPO | 4.5 | 830 | 17 | 16 | 61 |
| Example 3 | | | | | | | | |
| Experimental | Ethylmethylimidazolium | Cl− | TEMPO | 4.5 | 850 | 19 | 18 | 58 |
| Example 4 | | | | | | | | |
| Experimental | Ethylmethylimidazolium | TFSI− | TEMPO | 2 | 830 | 20 | 19 | 72 |
| Example 5 | | | | | | | | |
| Experimental | Ethylmethylimidazolium | TFSI− | TEMPO | 0.8 | 830 | 20 | 19 | 52 |
| Example 6 | | | | | | | | |
| Experimental | Ethylmethylimidazolium | TFSI− | TEMPO | 0.2 | 830 | 19 | 18 | 37 |
| Example 7 | | | | | | | | |
| Comparative | Lithium | TFSI− | TEMPO | — | 700 | | | 20 |
| Example 1 | | | | | | | | |
| Comparative | Lithium | TFSI− | Iodine | — | 550 | | | 50 |
| Example 2 | | | | | | | | |
| Comparative | Ethylmethylimidazolium | TFSI− | TEMPO | 0.1 | 830 | 19 | 18 | 20 |
| Example 3 | | | | | | | | |
| Comparative | Lithium | BF4− | TEMPO | 0.8 | 470 | 8 | 4 | 11 |
| Example 4 | | | | | | | | |
| Comparative | Lithium | PF6− | TEMPO | 0.8 | 480 | 5 | 2 | 3 |
| Example 5 | | | | | | | | |
| Comparative | Methylpropylpiperidinium | TFSI− | TEMPO | 4.5 | 720 | 8 | 5 | 55 |
| Example 6 | | | | | | | | |
| Comparative | Methylpropylpyrrolidinium | TFSI− | TEMPO | 4.5 | 740 | 10 | 8 | 35 |
| Example 7 | | | | | | | | |
| Comparative | 1-Butylpyridinium | TFSI− | TEMPO | 4.5 | 720 | 12 | 10 | 38 |
| Example 8 | | | | | | | | |
| Comparative | Tetrabutylammonium | TFSI− | TEMPO | 4.5 | 740 | 2 | 1 | 10 |
| Example 9 | | | | | | | | |

As can be seen from the results in Example 2 and Experimental Examples 1 and 3 to 7, the photoelectric conversion elements in which the liquid electrolyte containing 0.2 mol/L or more of an imidazolium cation were superior in initial voltage and durability. In particular, Example 2, in which the liquid electrolyte containing dimethylimidazolium cation, performed outstandingly in terms of initial voltage and durability. The photoelectric conversion elements of Comparative Examples 1 and 2, in which the liquid electrolyte containing no imidazolium salt, and that of Comparative Example 3, in which the liquid electrolyte containing an imidazolium salt but in a concentration of less than 0.2 mol/L, were all inferior in durability, as demonstrated by a great decrease in retention rate.

The retention rate was high in Example 2 and Experimental Examples 1, 3, and 4, in which the anion formed an ionic liquid (present in a concentration of nearly 5 mol/L), and especially high when the anion was TFSI⁻. Comparison of Experimental Examples 1 and 5 versus Experimental Examples 6 and 7 reveals that making the concentration of the imidazolium cation 2 mol/L or more is desirable in light of retention rate. Furthermore, comparison among Example 2, Experimental Example 1, and Experimental Example 3 indicates that the retention rate increased with decreasing number of carbon atoms on the alkyl chain of the imidazolium cation.

A photoelectric conversion element according to the present disclosure includes: a photoanode; a counter electrode; and a liquid electrolyte between the photoanode and the counter electrode. The liquid electrolyte contains a nitroxyl radical-bearing compound, 0.2 mol/L or more and 0.5 mol/L or less of dimethylimidazolium cation, and an anion.

In the liquid electrolyte, a concentration of any mediator other than the nitroxyl radical-bearing compound may be equal to or less than 0.001 mol/L. The anion may be at least one selected from the group consisting of halide anions, boron halide anions, phosphorus halide anions, and fluorocarbon anions. The anion may be a fluoroalkyl anion. The fluoroalkyl anion may be bis(trifluoromethanesulfonyl)imide anion. The nitroxyl radical-bearing compound may be 2,2,6,6-tetramethylpiperidine 1-oxyl.

The nitroxyl radical-bearing compound may be a radical compound that is 2,2,6,6-tetramethylpiperidine 1-oxyl or a derivative thereof. A mole fraction of an oxidized form of the radical compound, if any, in the liquid electrolyte may be equal to or less than 5% of a total quantity of the radical compound and the oxidized form. A distance between the photoanode and the counter electrode may be equal to or less than 30 μm.

A concentration of the radical compound in the liquid electrolyte may equal to or less than 50 mmol/L. The mole fraction of the oxidized form of the radical compound, if any, in the liquid electrolyte may equal to or less than 1% of the total quantity of the radical compound and the oxidized form.

The photoelectric conversion element may further comprise: a first substrate on which the photoanode is located; a second substrate on which the counter electrode is located; and a resin-containing sealer by which the liquid electrolyte is sealed between the first substrate and the second substrate.

At least one of the first substrate and the second substrate may have a depression having a depth of 10 μm or more. One of the first substrate and the second substrate may have a depression having a depth of 10 μm or more, and the other one of the first substrate and the second substrate may have a protrusion having a height of 10 μm or more. The liquid electrolyte may be sealed in a rectangular region with short size not exceeding 50 mm.

Photoelectric conversion elements according to the present disclosure can be used as, for example, dye-sensitized power generation elements capable of generating power even under relatively low-illuminance conditions, such as the indoors.

What is claimed is:

1. A photoelectric conversion element comprising:
a photoanode;
a counter electrode; and
a liquid electrolyte between the photoanode and the counter electrode, the liquid electrolyte containing a nitroxyl radical-bearing compound, 0.2 mol/L or more and 0.5 mol/L or less of dimethylimidazolium cation, and an anion,
the dimethylimidazolium cation represented by chemical formula 1: 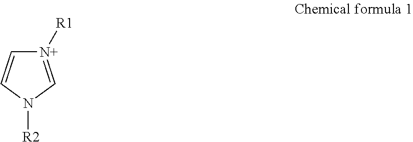
where each of R1 and R2 independently represents a methyl group.

2. The photoelectric conversion element according to claim 1, wherein the liquid electrolyte contains one or more mediators other than the nitroxyl radical-bearing compound, the one or more mediators each having a concentration not exceeding 0.001 mol/L.

3. The photoelectric conversion element according to claim 1, wherein the anion is at least one selected from the group consisting of halide anion, boron halide anion, phosphorus halide anion, and fluorocarbon anion.

4. The photoelectric conversion element according to claim 3, wherein the anion is a fluoroalkyl anion.

5. The photoelectric conversion element according to claim 4, wherein the fluoroalkyl anion is bis(trifluoromethanesulfonyl)imide anion.

6. The photoelectric conversion element according to claim 1, wherein the nitroxyl radical-bearing compound is 2,2,6,6-tetramethylpiperidine 1-oxyl.

7. The photoelectric conversion element according to claim 1, wherein:
the nitroxyl radical-bearing compound is a radical compound that is 2,2,6,6-tetramethylpiperidine 1-oxyl or a derivative thereof;
a mole fraction of an oxidized form of the radical compound in the liquid electrolyte is 0% or more and 5% or less of a total quantity of the radical compound and the oxidized form; and
a distance between the photoanode and the counter electrode does not exceed 30 μm.

8. The photoelectric conversion element according to claim 7, wherein a concentration of the radical compound in the liquid electrolyte does not exceed 50 mmol/L.

9. The photoelectric conversion element according to claim 7, wherein the mole fraction of the oxidized form of the radical compound in the liquid electrolyte 0% or more and 1% or less of the total quantity of the radical compound and the oxidized form.

10. The photoelectric conversion element according to claim 7, further comprising:
a first substrate on which the photoanode is located;
a second substrate on which the counter electrode is located; and
a resin-containing sealer by which the liquid electrolyte is sealed between the first substrate and the second substrate.

11. The photoelectric conversion element according to claim 10, wherein at least one of the first substrate and the second substrate has a depression having a depth of 10 μm or more.

12. The photoelectric conversion element according to claim 11, wherein one of the first substrate and the second substrate has a depression having a depth of 10 μm or more, and the other one of the first substrate and the second substrate has a protrusion having a height of 10 μm or more.

13. The photoelectric conversion element according to claim 11, wherein the liquid electrolyte is sealed in a rectangular region with short size not exceeding 50 mm.
